(19) United States
(12) Patent Application Publication
(10) Pub. No.: US 2022/0034726 A1
(43) Pub. Date: Feb. 3, 2022

(54) COLOR ANALYSIS DEVICE, ANALYSIS SYSTEM, QUALITY VISUALIZATION SYSTEM, AND COLOR ANALYZING METHOD

(71) Applicant: HITACHI, LTD., Tokyo (JP)

(72) Inventors: Yuji SUWA, Tokyo (JP); Shunsuke MORI, Tokyo (JP); Shigetaka TSUBOUCHI, Tokyo (JP); Masahiro KAWASAKI, Tokyo (JP)

(21) Appl. No.: 17/279,196

(22) PCT Filed: Sep. 17, 2019
(86) PCT No.: PCT/JP2019/036291

§ 371 Date: Mar. 24, 2021

(30) Foreign Application Priority Data
Oct. 2, 2018 (JP) 2018-187192

(51) Int. Cl. G01K 11/12; G01K 3/04; G01N 31/22

(52) U.S. Cl. CPC G01K 11/12; G01N 31/229; G01K 3/04

(57) ABSTRACT

A calculation device includes a storing unit that records discoloration characteristics about a sensor which changes color according to a size of physical quantity and a time when the physical quantity lasts, as a discoloration map with the physical quantity and the time as axes, for every sensor, and a physical quantity converting unit that specifies an area within each discoloration map corresponding to the color information of each sensor measured from a display area including the plural sensors having mutually different discoloration characteristics, calculates an overlapping area when the discoloration maps overlap each other as for the specified areas within the discoloration maps, and specifies a combination of the corresponding physical quantity and time from the position of the overlapping area within the discoloration map.

### TECHNICAL FIELD

The invention relates to a color analysis device, an analysis system, a quality visualization system, and a color analyzing method.

### BACKGROUND ART

There are a lot of color sensors which measure physical quantity and show the quantity or the intensity with a change in color. Although it depends on an object to be measured, a color sensor is useful particularly in the case where it is difficult to convert the measured result into electric signals and it is easier to display the result with a change in color, and in the case of measuring physical quantity at a low cost.

An object to be measured of a color sensor is an environmental condition including, for example, temperature, temperature history, humidity, light, and various types of gas concentration.

Furthermore, there are some color sensors which detect and display pH of liquid, various types of ion concentration, various types of medical agent concentration, various types of amino acid and protein concentration, existence of virus and bacteria, and the like.

Of these color sensors, there are some reversible ones in which color changes only when they are exposed to the physical quantity (temperature, light, gas and the like) to be measured and the color is returned when the physical quantity is decreased and other irreversible ones in which color is not returned once when discoloration happens. The irreversible color sensors can be used to display the maximum value of the physical quantity of an object to be measured during the measurement period.

A color sensor for detecting a temperature starts discoloration when exceeding or falling below a specified value. Therefore, it is possible to detect a deviation from the specified temperature; however, it is difficult to detect an elapsed time from the deviation from the specified temperature. Particularly, when a color sensor is used for temperature management of food products and medical products, not only the temperature but also the elapsed time from the temperature deviation is required. That is because the quality of the food products and the medical products is influenced by not only the temperature but also the time elapsed from the temperature deviation.

Patent Literature 1 discloses a method of specifying intensity of physical quantity and time period by using many types of color sensors corresponding to the combinations of the deviated temperature and the deviated time. In a color sensor for temperature history, discoloration characteristics are various in every type of ink to be used. The above uses that the characteristics showing a rise in the color changing speed according to an increase in the intensity of the physical quantity are various in every type of the sensors.

### CITATION LIST

### Patent Literature

Patent Literature 1: International Publication No. 2017/203850

### SUMMARY OF INVENTION

### Technical Problem

FIG. 10 is a time-series graph indicating a temperature change as the measured result of the color sensor for displaying a temperature history.

In the color sensor for displaying a temperature history, for example, when exceeding a specified temperature, discoloration starts and when falling below the above, the discoloration stops. The deviated value from the specified temperature is defined as a “deviated temperature” and the time period when the deviated temperature happens is defined as a “deviated time”. According to the higher deviated temperature, the amount of discoloration of the color sensor is increased, and according as the deviated time gets longer, the amount of discoloration is increased. In other words, according as the area of a rectangle (=deviated time×deviated temperature) indicating the deviated portion shaded in FIG. 10 gets larger, the amount of discoloration of the color sensor is increased.

FIG. 11 is a time-series graph indicating another temperature change different from FIG. 10. In FIG. 10, as the deviated temperature at a low temperature continues for a longer period, it takes time to change color and the color changing speed is slow. On the other hand, in FIG. 11, as the deviated temperature at a high temperature occurs for a short time, the color changing speed is fast.

This is not restricted to the color sensor for a temperature history, but many irreversible color sensors for measuring the physical quantity change color for a shorter time when the intensity of the physical quantity is higher, while they change color for a longer time when the intensity is lower, according to the color changing mechanism.

For example, when the color sensor of the temperature history is used for monitoring the distribution of cold insulated food, a damage to the food caused by the deviation from the cold insulation temperature depends on the amount of the discoloration of the color sensor for the temperature history. In other words, when the deviation of the temperature is small, a damage is small unless the deviation lasts for a longer time; while when the deviation is large, a damage is great even if it lasts for a short time.

While, according to the use purpose of the color sensor for the temperature history, there is the case where the numeral value of the deviated temperature and the numeral value of the deviated time exposed to the deviated temperature are desired to be specified separately. It is preferable that the deviated temperature and the deviated time are separately specified when a damage to the food is intended to be estimated at a higher accuracy.

From the discoloration amount displayed as the result in the color sensor for the temperature history, however, it is difficult to determine whether it is the case of a small deviation for a long time as shown in FIG. 10 or the case of a large deviation for a short time as shown in FIG. 11. The shaded rectangles indicating the deviated portions in FIGS. 10 and 11 show only that the color changes as the result of the intensity of the physical quantity accumulated in time; therefore, it does not mean that the area of the rectangle (=deviated time×deviated temperature) agrees with the amount of the discoloration.

Therefore, the invention aims to specify the intensity of the physical quantity and the exposed time separately, according to the color information of the color sensor changing color depending on the intensity of the physical quantity and the exposed time.

Solution of Problem

In order to solve the above problem, a color analysis device of the invention has the following characteristics.

The invention is characterized by comprising a storing unit that records a size of physical quantity to be measured and discoloration characteristics of a sensor changing color depending on a time period when the above physical quantity lasts, for every sensor, as a discoloration map with the physical quantity and the time period as axes, and a physical quantity converting unit that specifies an area within each discoloration map corresponding to color information of each sensor measured from a display area including a plurality of sensors having mutually different discoloration characteristics, calculates an overlapping area when the discoloration maps overlap each other as for the specified areas within the discoloration maps, and specifies a combination of the corresponding physical quantity and time from the position of the overlapping area within the discoloration map.

The other means will be described later.

### Advantageous Effects of Invention

According to the invention, it is possible to specify the intensity of the physical quantity and the time exposed to the above separately, according to the color information of the color sensor changing color depending on the intensity of the physical quantity and the time period exposed to the above.

### BRIEF DESCRIPTION OF DRAWINGS

FIG. 1 is a schematic view showing a method of narrowing down a physical quantity by use of two types of discoloration maps of color sensors according to one embodiment of the invention.

FIG. 2 is a constitutional view of an analysis system by use of the two types of the color sensors according to one embodiment of the invention.

FIG. 3 is a detailed constitutional view of the analysis system of FIG. 2 according to one embodiment of the invention.

FIG. 4 is a flow chart showing the processing of a physical quantity converting unit of FIG. 3 according to one embodiment of the invention.

FIG. 5 is a schematic view showing a method of narrowing down the temperature and time by use of three types of the discoloration maps of the color sensors according to one embodiment of the invention.

FIG. 6 is a schematic view showing a method of searching for an area overlapping in whole by expanding each width of equivalent color areas in the discoloration map in FIG. 5 according to one embodiment of the invention.

FIG. 7 is a time-series graph showing a temperature change during a plurality of measurement periods according to one embodiment of the invention.

FIG. 8 shows discoloration maps modified according to one embodiment of the invention and an overlap map thereof.

FIG. 9 is a constitutional view of a quality control system according to one embodiment of the invention.

FIG. 10 is a time-series graph showing a temperature change as the measurement result of the color sensor for displaying a temperature history.

FIG. 11 is a time-series graph showing another temperature change different from FIG. 10.

### DESCRIPTION OF EMBODIMENTS

Hereinafter, one embodiment of the invention will be described in details referring to the drawings.

### First Embodiment

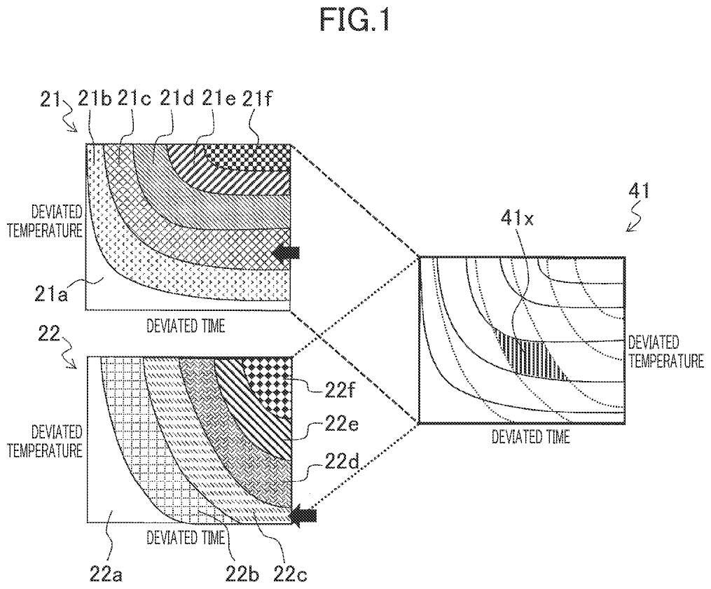

FIG. 1 is a schematic view showing a method of narrowing down a physical quantity by use of two types of discoloration maps of color sensors.

The color sensors 11 and 12 display a history of each detected temperature as color. Although the description is made here in the case of using a temperature detection ink as a color sensor, with a temperature as the physical quantity of the object to be measured, the invention can be also applied to a sensor which measures another physical quantity such as humidity. The color sensors 11 and 12 change color at a point of exceeding a specified temperature (hereinafter, referred to a set temperature) and at a point of falling below the set temperature, they stop changing color. The color once changed is not returned even when the temperature gets cool.

This period of discoloration is defined as a “deviated time” and the temperature exceeding the set temperature during the deviated time is defined as a “deviated temperature”. The amount of the discoloration in each of the color sensors 11 and 12 gets larger according as the deviated time gets longer and the deviated temperature gets higher. Discoloration characteristics such as which temperature to be set as the set temperature or the color changing speed to be set fast or slow can be changed by adjusting the material forming inks.

Although in the embodiment, a temperature-detecting ink which starts discoloration at a point of exceeding the specified temperature is used as the color sensor, a temperature-detecting ink which starts discoloration at a point of falling below the specified temperature can be used.

Discoloration maps 21 and 22 in FIG. 1 are prepared for the color sensors 11 and 12 having mutually different discoloration characteristics. The discoloration map 21 is a distribution view of colors corresponding to the deviated temperature and the deviated time in the color sensor 11. The discoloration map 22 is a distribution view of colors corresponding to the deviated temperature and the deviated time in the color sensor 12. These two types of the discoloration maps 21 and 22 are previously created and prepared for every type of ink to be used. Although in the embodiment, the distribution view of the colors corresponding to the deviated temperature and the deviated time is used as the discoloration map, a distribution view of the colors corresponding to the temperature and the deviated time may be used as the discoloration map.

The discoloration maps 21 and 22 show the discoloration characteristics for every color sensor 11 and 12 as the distribution of the colors on a plane surface with the deviated temperature and the deviated time as two axes. In the discoloration maps 21 and 22, generally the amount of the discoloration is larger in the upper-rightward portion (according to the higher deviated temperature and the longer deviated time), and the amount of the discoloration is smaller in the lower-leftward portion (according to the lower deviated temperature and the deviated time being nearer to zero). Curves within the discoloration maps 21 and 22 are made by connecting the points of the same color information and hereinafter, they are referred to as an “equivalent color line”, following a contour line of a map.

Here, when one equivalent color line is specified in the discoloration maps 21 and 22 according to the color information, it is difficult to narrow down an area to a thin line-shaped area in many cases, considering the measurement errors. Accordingly, in this description, the area within the discoloration maps 21 and 22 specified according to the color information is considered as a band having some width not a line. In FIG. 1, the area shaded in the same pattern considered as the same color information is referred to as the “equivalent color area”. The discoloration map 21 includes six equivalent color areas 21a to 21f and the discoloration map 22 includes six equivalent color areas 22a to 22f.

In the case of using only one type of the color sensor 11 and its discoloration map 21, it is possible to measure the color and specify one equivalent color line; however, the physical quantity [deviated time, deviated temperature] indicated by the equivalent color line covers in a wide range and cannot be restricted to a narrow range.

Therefore, the two types of the color sensors 11 and 12 having different discoloration characteristics and the discoloration maps 21 and 22 thereof are prepared and the two types of the color sensors 11 and 12 are simultaneously used for measurement. The two types of the discoloration maps 21 and 22 are the same in that the amount of the discoloration upper rightward is larger and that the amount of the discoloration lower leftward is smaller; however, the distribution of the middle equivalent color areas is different from each other.

Therefore, when the discoloration maps 21 and 22 are overlaid on each other as an overlap map 41, the equivalent color areas of the both overlap. The overlap map 41 is obtained by overlapping the two types of the discoloration maps 21 and 22 so that each two axes in the above maps should take the same value.

By performing the following (process 1) to (process 4) sequentially, the physical quantity [deviated time, deviated temperature] can be narrowed down from the color information of the color sensors 11 and 12.

(Process 1) The color information of the color sensors 11 and 12 is obtained.
(Process 2) The color measured according to the process 1 is correlated with the equivalent color area in the discoloration map, in every color sensor. For example, assume that the color of the color sensor 11 corresponds to the equivalent color area 21c as shown by the arrow in the discoloration map 21 and that the color of the color sensor 12 corresponds to the equivalent color area 22c as shown by the arrow in the discoloration map 22.
(Process 3) The overlap map 41 is used to calculates an overlapping area 41x. When the equivalent color areas 21c and 22c have fairly narrow widths and can be specified as two equivalent color lines, the intersection of the two equivalent color lines is represented as the overlapping area 41x.
(Process 4) The position of the horizontal axis of the overlapping area 41x in the overlap map 41 is defined as the deviated time and the position of the vertical axis of the overlapping area 41x is defined as the deviated temperature. According to this, by using the two types of the temperature-detecting inks having different discoloration characteristics, the physical quantity [deviated time, deviated temperature] can be narrowed down.

Here, according as the range to be narrowed as the overlapping area 41x of the equivalent color areas 21c and 22c corresponding to the equivalent color lines is narrower, the accuracy of the physical quantity [deviated time, deviated temperature] gets higher. Accordingly, the discoloration characteristics of the inks as the color sensors 11 and 12 are preferably different from each other as much as possible.

When the discoloration characteristics are similar, the discoloration maps 21 and 22 are mutually in the similar shape and the angle of crossing the equivalent color lines in the equivalent color area 21c and the equivalent color area 22c is shallow. Therefore, the area of the overlapping area 41x gets wider, which prevents from narrowing down to a quite narrow area.

In order to cross the equivalent color lines at a sufficiently sharp angle, for example, there is considered such a method that the ink as the color sensor 11 changes color comparatively faster with the saturated color information strongly depending on the temperature and that the ink as the color sensor 12 changes color slowly with a small difference of the color information depending on the temperature.

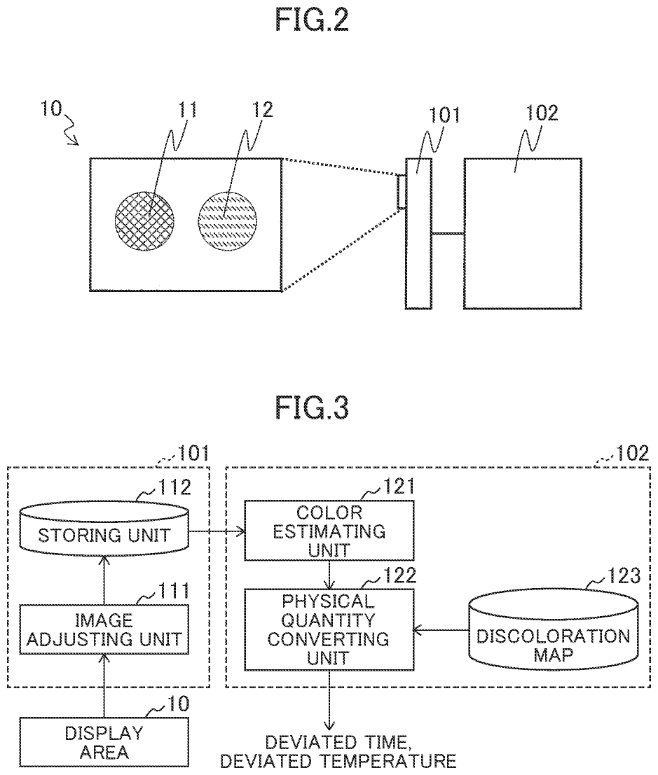

FIG. 2 is a constitutional view of an analysis system using the two types of the color sensors.

The two types of the color sensors 11 and 12 are built in a display area 10 formed on the surface of an indicator and this display area 10 is set in a place to be measured. Further, two or more types of color sensors are attached to the object to be measured. After elapse of a period to be measured, this display area 10 is photographed by a photographic equipment 101. The photographic equipment 101 may be a digital camera, a cellular or a smartphone with camera. The photographic equipment 101 transfers the taken image file to a connected calculation device 102.

The calculation device 102 working as a color analysis device is formed as a general personal computer or a server including CPU (Central Processing Unit) and storing means such as memory, hard disk, and the like. This computer operates a control unit (controlling means) formed by various processing units, according to the CPU running a program (application and App of smartphone) read on the memory.

FIG. 3 is a detailed constitutional view of the analysis system of FIG. 2. The photographic equipment 101 includes an image adjusting unit 111 and a storing unit 112. The calculation device 102 includes a color estimating unit 121, a physical quantity converting unit 122, and a storing unit of discoloration maps 123. The calculation device 102 may further include a color information obtaining unit which obtains the color information of the color sensors from the photographic equipment 101. The color information of the color sensor obtained by the color information obtaining unit is modified and corrected in the color estimating unit.

In the image adjusting unit 111 of the photographic equipment 101, generally the auto-white balance adjustment processing is performed, to create an image file in a format of at least jpg and the like and the image file is stored in the storing unit 112. The format of the image file includes various formats such as png, tif, bmp, and the like other than jpg and any of them may be used. In a format with a smaller number of colors, however, accuracy of data is spoiled; therefore, a format that can represent each pixel color with one byte and more of R, G, and B is preferable.

The color estimating unit 121 of the calculation device 102 receives the image file of the storing unit 112, assigns a plurality of pixels to the color sensors 11 and 12, and extracts the color of each area as a mean value. Here, as described in Japanese Unexamined Patent Application Laid-Open No. 2012-93277, color samples different from those of the color sensors 11 and 12 may be used to correct the color of the color sensors 11 and 12 when the color correction is possible.

As having been described in the (process 1) to (process 4) in FIG. 1, the physical quantity converting unit 122 of the calculation device 102 specifies a combination of the physical quantity [deviated time, deviated temperature] by using the obtained colors of the two types of the sensors and the discoloration maps 123 (corresponding to the discoloration maps 21 and 22 in FIG. 1), and records the combination as an observed value. Here, when it is more preferably represented as the range with the upper limit and the lower limit than as that of one value, the above does so.

The observed value obtained by the physical quantity converting unit 122 is used as the input data as it is when there is further analysis using the above value. When the photographic equipment 101 is a smartphone and the like, the result is contrarily transferred and also displayed on the photographic equipment 101.

Here, a connection between the photographic equipment 101 and the calculation device 102 may be wired or wireless, or may be a connection through the Internet. Further, the data transfer through an SD memory card and the like may be considered as a type of connection.

When the photographic equipment 101 is a programmable equipment like a smartphone, all the processes up to extracting the sensor color from the image in the color estimating unit 121 may be performed within the photographic equipment 101 and only the result may be transferred to the calculation device 102 and the physical quantity converting unit 122 may be operated therein. In this case, the amount of the transfer data is much more saved and a time for communication is also saved advantageously. Further, not only the color estimating unit 121 but also the physical quantity converting unit 122 may be operated within the photographic equipment 101 as the smartphone, and the both of the photographic equipment 101 and the calculation device 102 may be served in a single body of the smartphone.

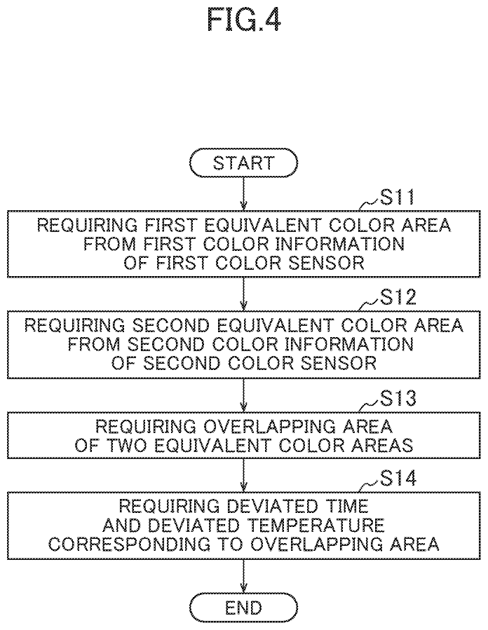

FIG. 4 is a flow chart showing the processing of the physical quantity converting unit 122 of FIG. 3. In S11, the physical quantity converting unit 122 calculates a first equivalent color area (corresponding to the equivalent color area 21c in the process 2) from the first color information of the color sensor 11 measured in the (process 1) described in FIG. 1.

In S12, the physical quantity converting unit 122 calculates a second equivalent color area (corresponding to the equivalent color area 22c in the process 2) from the second color information of the color sensor 12 measured in the (process 1) described in FIG. 1.

In S13, the physical quantity converting unit 122 calculates an overlapping area of the two equivalent color areas (corresponding to the overlapping area 41x in the process 3).

In S14, the physical quantity converting unit 122 calculates the physical quantity [deviated time, deviated temperature] corresponding to the overlapping area (corresponding to the process 4). Here, in addition to the physical quantity [deviated time, deviated temperature] calculated in S14, the physical quantity converting unit 122 may output also the accuracy information of the physical quantity, based on the overlapping area used in S13 when calculating the physical quantity. For example, the narrower the overlapping area is, the better the accuracy information of the physical quantity gets.

As mentioned above, referring to FIGS. 1 to 4, in the first embodiment, there has been described a method of narrowing down the physical quantity using the discoloration maps 21 and 22 of the two types of the color sensors.

### Second Embodiment

A second Embodiment describes a method of narrowing down the physical quantity at a higher accuracy than in the case of using the two types in the first embodiment, by simultaneously using three or more types of color sensors. In the second embodiment, it is possible to determine the physical quantity [deviated time, deviated temperature] at a higher accuracy by using the three or more types of the color sensors having different discoloration characteristics, in the same way as that of the first embodiment.

FIG. 5 is a schematic view showing the method of narrowing down a temperature and time, using the discoloration maps of the three types of the color sensors.

When analyzing the equivalent color lines in the discoloration map 123 as the equivalent color area, the range of the physical quantity [deviated time, deviated temperature] becomes an overlapping area of the three types or more of bands; therefore, generally speaking, it is possible to narrow down to a narrower range.

There are three equivalent color areas in total in the discoloration map 123 of FIG. 5, including a first equivalent color area surrounded by the curved lines 211 and 212, a second equivalent color area surrounded by the curved lines 221 and 222, and a second equivalent color area surrounded by the curved lines 231 and 232.

As shown in FIG. 5, there are overlapping areas 281, 282, and 283 each consisting of two equivalent color areas; however, there is the case of no overlapping area in all the (three) color sensors used according to a measurement error.

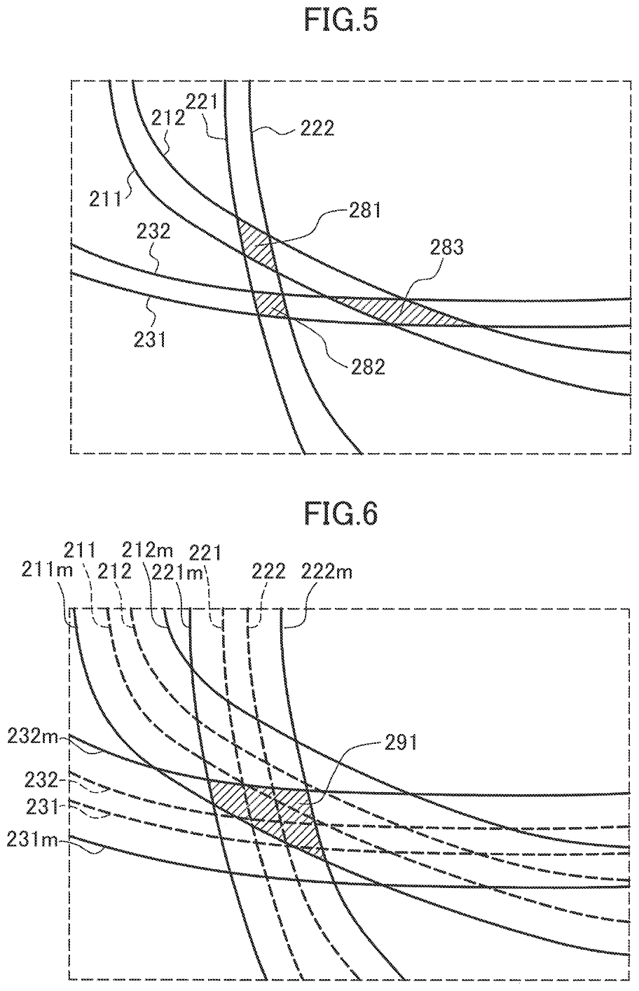

FIG. 6 is a schematic view showing a method of searching for an area overlapping in all by expanding the widths of the equivalent color areas in the discoloration map of FIG. 5.

Considering the measurement error of the color sensor, each width of the equivalent color areas is expanded to the peripheral portion. Boundary lines of the equivalent color area before expansion are indicated by a dotted line and the boundary lines of the equivalent color areas after the expansion are indicated by a solid line. In short, according as the expanded width is larger, the measurement error of the color sensor is estimated larger.

For example, the first equivalent color area surrounded by the curved lines 211 and 212 is expanded to the width of curved lines 211m and 212m. In short, a reference sign “m” added to the end of the sign of the curved line in FIG. 6 shows the curved line after the expansion of the width. Similarly, the second equivalent color area surrounded by the curved lines 221 and 222 is expanded to the width of curved lines 221m and 222m, and the third equivalent color area surrounded by the curved lines 231 and 232 is expanded to the width of curved lines 231m and 232m.

As mentioned above, by expanding each width, the physical quantity converting unit 122 can newly detect an overlapping area 291 of all the (three) color sensors. In the example of FIG. 6, for the sake of easy description, the overlapping area 291 is shown larger; however, the narrower the overlapping area is, the higher the accuracy of the physical quantity gets. Accordingly, it is preferable that the physical quantity converting unit 122 gradually expands the widths of the equivalent color areas to get the narrowest possible overlapping area.

Here, there is a possibility that the position of the physical quantity [deviated time, deviated temperature] may differ depending on which sensor's error to be estimated larger. Therefore, according to a predetermined method, the degree of error is determined in each sensor. As the predetermined method, a difference between the original color to be indicated by each sensor and the actually measured color as for the obtained physical quantity [deviated time, deviated temperature] is digitalized, to determine the error so as to make the sum of the square minimum.

### Third Embodiment

A third embodiment describes a method of specifying the physical quantity and time when observing the color of a color sensor even in the midst of the measurement not only the last color.

In the first embodiment, there has been described a method of specifying the physical quantity [deviated time, deviated temperature] when exceeding the set temperature using the temperature-detecting ink.

The first embodiment is in such a situation as keeping at a predetermined temperature deviated from the set temperature during a predetermined time period of the measurement and keeping at a temperature lower than the above during the other period than the above. This means that even if the actual object changes in temperature little by little according to the time, the above is measured approximately as the temperature change of stepwise function.

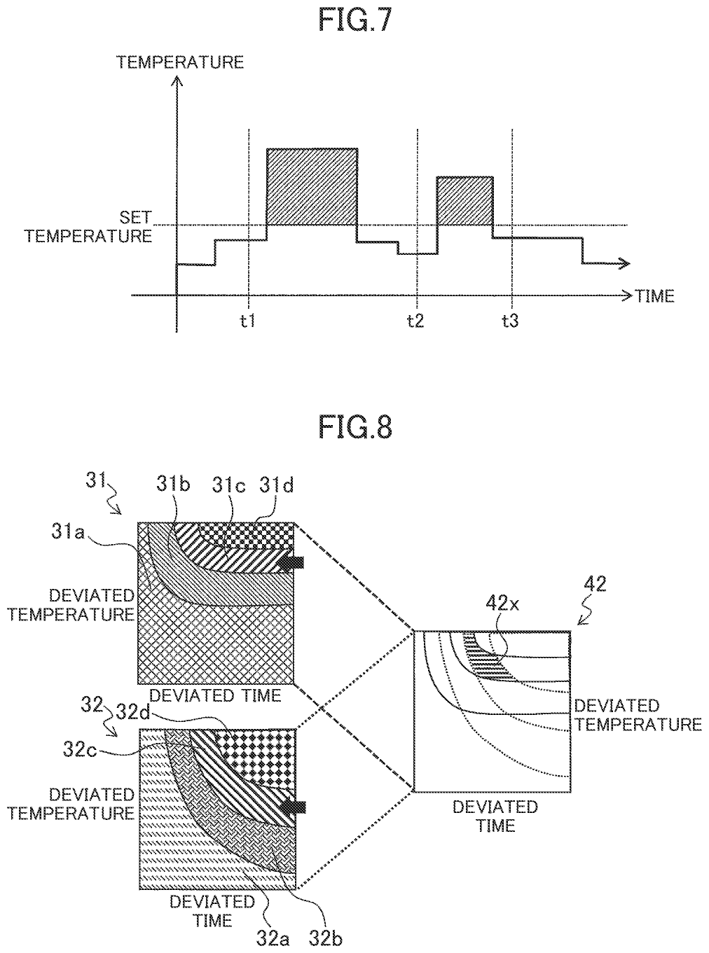

FIG. 7 is a time-series graph showing a temperature change during a plurality of measurement periods. Assume that during a first measurement period t1 to t2, the temperature is once deviated from the set temperature and that also during a second measurement period t2 to t3, the temperature is once deviated from the set temperature. To analyze the change in the temperature according to the time more specifically, the color of the temperature-detecting ink should be recorded in every step (midst) of the measurement period if possible. In this case, the change in the temperature according to the time is approximated as a stepwise function during each measurement period. The measurement period is divided for the number of the times of this stepwise function's deviation from the set temperature.

The color estimating unit 121 records the color of the temperature-detecting ink at the point t2 on the way of the measurement. The physical quantity converting unit 122 can specify the physical quantity [deviated time, deviated temperature] covering from the measurement starting point t1 to the point t2, as the measurement result of the first measurement period.

As for the second measurement period t2 to t3 thereafter, the measurement is similarly started from the color of the ink at the point t2. Therefore, the physical quantity converting unit 122 modifies the discoloration map to make the color of the ink at the point t2 as the starting point. The physical quantity converting unit 122 can narrow the physical quantity [deviated time, deviated temperature] according to the modified discoloration map.

As described in FIG. 7 in the above, it is possible to know a detailed temperature history on the whole by calculating the physical quantity [deviated time, deviated temperature] in a plurality of measurement periods being divided.

FIG. 8 shows the discoloration maps 31 and 32 modified at a point t2 in FIG. 7 and the overlap map 42 thereof.

The physical quantity converting unit 122 modifies the discoloration maps 21 and 22 (in FIG. 1) before the modification to the discoloration maps 31 and 32, based on the color information of the color sensor recorded at the point t2. According to the modified discoloration maps 31 and 32, the physical quantity converting unit 122 calculates the physical quantity [deviated time, deviated temperature] during the second measurement period t2 to t3.

When each x-axis in the discoloration maps 21 and 22 is defined as a time, each y axis is defined as a temperature, and the equivalent color line curve of the color recorded on the way is defined as x=f(y), the physical quantity converting unit 122 can prepare the modified discoloration maps 31 and 32 with the color on the way as a starting point, through the conversion of x′=x−f(y) on the whole area of y.

For example, assume that the color information of the color sensor 11 at the point t2 is the equivalent color area 21d of the discoloration map 21 in FIG. 1 and that the color information of the color sensor 12 at the point t2 is the equivalent color area 22d of the discoloration map 22 in FIG. 1. The physical quantity converting unit 122 modifies the discoloration maps 21 and 22 with the equivalent color areas 21d and 22d as each starting point, hence to create the discoloration maps 31 and 32.

Then, the physical quantity converting unit 122 performs the processing shown in the flow chart of FIG. 4, using the discoloration maps 31 and 32 instead of the discoloration maps 21 and 22. According to this, it is possible to specify the physical quantity [deviated time, deviated temperature] corresponding to the overlapping area 42x in the overlap map 42 between the discoloration maps 31 and 32, as the measurement result of the second measurement period t2 to t3.

As having been described in the above, in this embodiment, the physical quantity converting unit 122 is regarded as the calculation device 102 calculating the physical quantity [deviated time, deviated temperature] according to the overlapping area 41x in the overlap map 41 of the discoloration maps 21 and 22 in FIG. 1.

According to this, as shown in the first embodiment, the deviated temperature and the deviated time can be separately specified and further the number of the types of the color sensors 11 and 12 can be restricted, which makes the measurement of the physical quantity in a simple way at a low cost.

Further, as shown in the second embodiment, three types of color sensors are used, which can improve the measurement accuracy of the physical quantity.

Then, as shown in the third embodiment, the same color sensors 11 and 12 can be used even for a plurality of measurement periods by using the discoloration maps 31 and 32 modified in every measurement period, which can restrain the number of the types of the color sensors 11 and 12.

The invention is not restricted to the above-mentioned embodiments but it includes various modified examples. For example, the above-mentioned embodiments are described in details for the sake of easy understanding of the invention; however, it is not restricted to the constitution including all the described components.

A part of the constitution in one embodiment may be replaced to another in the other embodiment and further, a component in one embodiment may be added to the constitution in the other embodiment.

Further, a part of the constitution in each embodiment can be added to, deleted from, replaced with another component. Further, a part or all of the above components, functions, processing units, and processing means may be realized by hardware, for example, which is designed with integrated circuit.

Alternatively, the above-mentioned components and functions may be realized in software by a processor reading and executing a program for realizing each function.

The information such as a program, table, file, and the like for realizing each function may be put on a storing device such as a memory, hard disk, SSD (Solid State Drive), and the like, or storing medium such as IC (Integrated Circuit) card, SD card, DVD (Digital Versatile Disc), and the like.

Further, the control lines and the information lines considered necessary for the description are shown and all the control lines and the information lines of the product are not necessarily shown. Actually, it can be considered that almost all the components are mutually connected to each other.

Further, a communication means for connecting each device is not restricted to a wireless LAN but it may be changed to a wired LAN and the other communication means.

### Fourth Embodiment

In a fourth embodiment, a quality visualization system 200 for estimating the quality such as freshness, degradation degree, maturation degree, and the like of the object such as food and medical products will be described. The quality visualization system 200 applies the combination data of the deviated temperature and the deviated time obtained according to the color analyzing method by the color analysis device in the first to the third embodiments (hereinafter, referred to the combination data of the physical quantity and the time), to the estimation of the quality.

The quality visualization system 200 collates the combination data of the physical quantity and the time with quality changing speed data showing as the following (data 1) to (data 3) by way of example, hence to be able to estimate the quality of the object. Further, each estimated quality can be digitalized as the quality index.

(Data 1) Freshness estimation data indicating the freshness changing speed according to the preservation period when preserving food such as meat, fish, fruit, and the like at each temperature.
(Data 2) Degradation estimation data indicating the degradation speed according to the preservation period when preserving a medical product at each temperature.
(Data 3) Maturation estimation data indicating the maturation speed according to the preservation period when preserving the food such as meat, fish, fruit, and the like at each temperature.

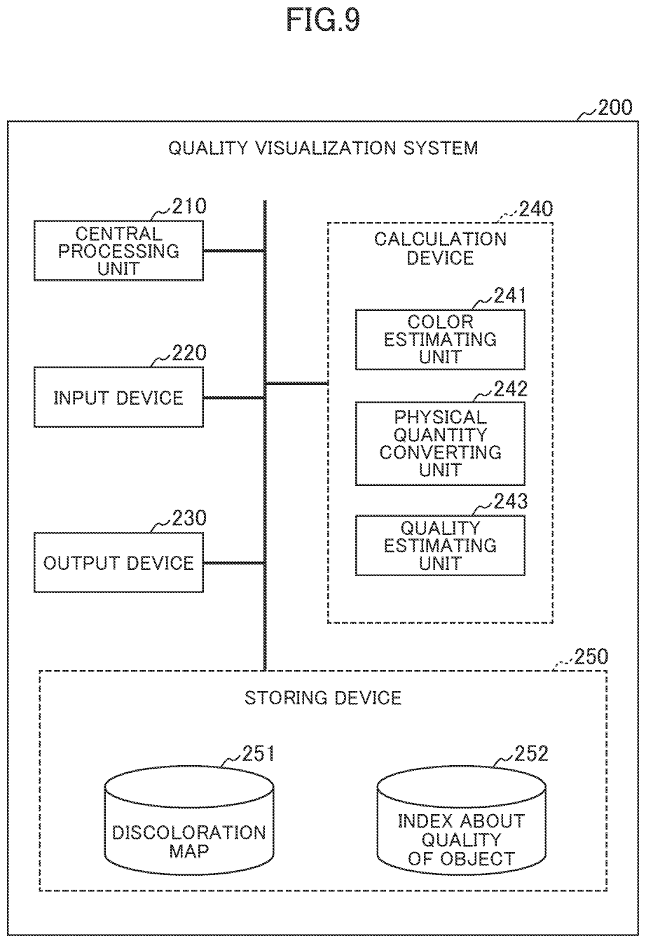

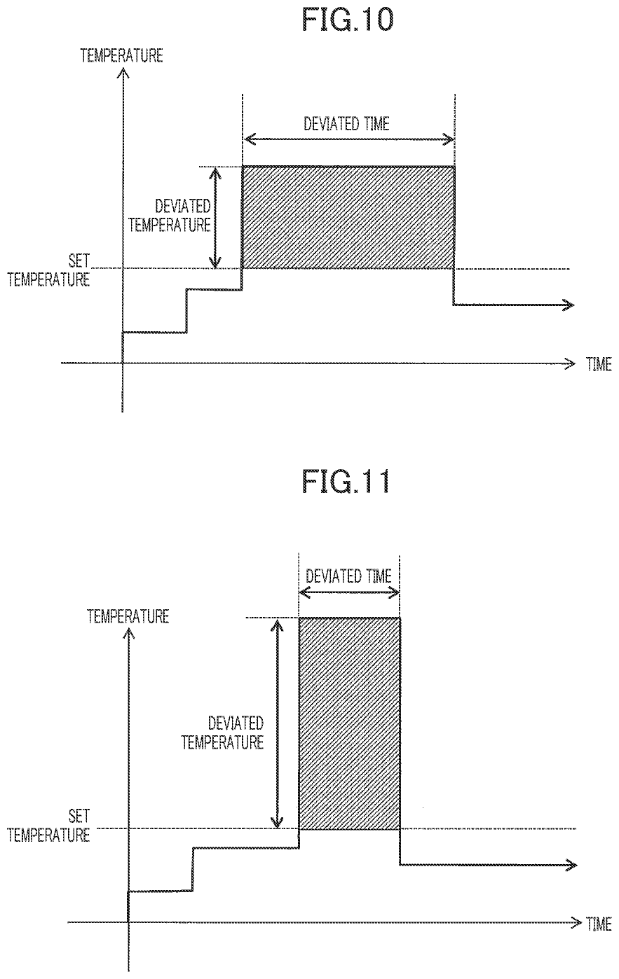

FIG. 9 shows a constitutional view of the quality visualization system 200. The quality visualization system 200 is a general computer, including a central processing unit 210, an input device 220 such as a camera, a label reader, a mouse, a keyboard, and the like, an output device 230 such as a display and the like, a calculation device 240, and a storing device 250. The respective components of the quality visualization system 200 are mutually connected to each other through bus.

Two and more types of sensors are attached to the object targeted for quality estimation. The sensors change color according to the size of the physical quantity to be measured, depending on the lasting time period of the physical quantity.

The input device 220 works as a color information obtaining unit which obtains the color information of each sensor attached to the object.

The output device 230 visualizes the quality of the object estimated by a quality estimating unit 243 through the output processing such as displaying the above on a screen of a display.
The storing device 250 records the discoloration characteristics of each sensor attached to the object, as the discoloration map 251 (similarly to the discoloration maps 21 and 22 in FIG. 1) with the physical quantity and the time as axes.

The storing device 250 records indexes 252 about the quality of each object to be measured. The index of freshness and maturation degree is various according to the type of a product. Therefore, in order to select a proper index, the storing device 250 records the indexes 252 about the quality of each object, for every object to be measured.

The indexes 252 about the quality of the object include, for example, chlorophyll, vitamin, sugar content, and the like as for vegetable, K-value indicating degradation degree of nucleic acid (ATP) and flee glutamic acid and the like as for meat and fish, and potency as for medicine.

Further, the storing device 250 also records, as the index 252 about the quality of the object, the quality changing speed data (the above data 1 to data 3) used for calculation of the quality index, in addition to the type of the object and the type of the quality index.

The calculation device 240 includes a color estimating unit 241, a physical quantity converting unit 242, and the quality estimating unit 243. Programs of these processing units are loaded by the central processing unit 210, from the storing device 250 into the calculation device 240. According to this, the central processing unit 210 realizes the respective functions of the programs.

The color estimating unit 241 modifies and corrects the color information of each sensor obtained by the input device 220, similarly to the color estimating unit 121 in FIG. 3.

The physical quantity converting unit 242 specifies an area of the discoloration map 251 corresponding to the color information of each sensor and calculates an overlapping area when the discoloration maps 251 overlap with each other as for each specified area within each discoloration map 251, similarly to the physical quantity converting unit 122 in FIG. 3. The physical quantity converting unit 242 specifies the corresponding combination data of the physical quantity and the time from the position of the obtained overlapping area in the discoloration map 251.

The quality estimating unit 243 estimates the quality such as freshness, degradation degree, maturation degree, and the like as for the object, according to the combination data of the physical quantity and the time specified by the physical quantity converting unit 242 and the quality changing speed data of the indexes 252 about the quality of the object read from the storing device 250. The quality estimating unit 243 may estimate the digitalized quality.

As set forth hereinabove, it is also possible to perform the collation with the quality changing speed data and display the freshness, the degradation degree, and the maturation degree, inside the quality visualization system 200.

### LIST OF REFERENCE SIGNS

10 display area
11, 12 color sensor
21, 22 discoloration map
41, 42 overlap map
101 photographic equipment
102 calculation device
111 image adjusting unit
112 storing unit
121 color estimating unit
122 physical quantity converting unit
200 quality visualization system
210 central processing unit
220 input device
230 output device
240 calculation device
241 color estimating unit
242 physical quantity converting unit
243 quality estimating unit
250 storing device
251 discoloration map
252 index about the quality of object

1. A color analysis device characterized by comprising
a storing unit that records discoloration characteristics about a sensor which changes color according to a size of physical quantity to be measured and a time when the physical quantity lasts, as a discoloration map with the physical quantity and the time as axes, for every sensor, and
a physical quantity converting unit that specifies an area within each discoloration map corresponding to color information of each sensor measured from a display area including the plural sensors having mutually different discoloration characteristics, calculates an overlapping area when the discoloration maps overlap each other as for the specified areas within the discoloration maps, and specifies a combination of the corresponding physical quantity and time from the position of the overlapping area within the discoloration map.

2. The color analysis device according to claim 1, characterized in that
when there is no overlapping area, the physical quantity converting unit calculates the overlapping area by expanding the areas within the discoloration maps corresponding to the color information of the respective sensors to the peripheries.

3. The color analysis device according to claim 1, characterized in that
when there are a plurality of measurement periods, the physical quantity converting unit modifies the corresponding discoloration map for the next measurement period, based on the color information of each sensor measured after the previous measurement period, and specifies an area within each discoloration map corresponding to the color information of each sensor measured during the next measurement period, according to the modified discoloration map.

4. The color analysis device according to claim 1, characterized by further comprising
a color information obtaining unit that obtains the color information of each sensor in the display area.

5. An analysis system comprising
the color analysis device according to claim 1, an indicator including the display area having a plurality of sensors, and a photographic equipment for taking picture of the indicator, characterized in that
of the plural sensors within the indicator, one sensor comprises an ink with a faster color changing speed and saturated color information strongly depending on temperature, and the other sensor comprises an ink with a slower color changing speed than the above sensor and a small difference of the color information in the temperature.

6. A quality visualization system characterized by comprising
a color information obtaining unit that obtains color information of each sensor, from an object with two and more types of sensors attached there which change color according to a size of physical quantity to be measured and a time when the physical quantity lasts,
a storing unit that records discoloration characteristics of the respective sensors, as each discoloration map with the physical quantity and the time as axes, for every sensor,
a physical quantity converting unit that specifies an area within each discoloration map corresponding to the color information of each sensor obtained by the color information obtaining unit, calculates an overlapping area when the discoloration maps overlap each other as for the specified areas within the discoloration maps, and specifies a combination of the corresponding physical quantity and time from the position of the overlapping area within the discoloration map,
a quality estimating unit that estimates quality of the object, from the combination of the physical quantity and time specified by the quantity converting unit, referring to data indicating a speed of quality changing according to the physical quantity of time, defined in every index about the quality of the object, and
an output unit that visualizes the quality of the object.

7. The quality visualization system according to claim 6, characterized in that
when there is no overlapping area, the physical quantity converting unit calculates the overlapping area by expanding the areas within the discoloration maps corresponding to the color information of the respective sensors to the peripheries.

8. The quality visualization system according to claim 6, characterized in that
when there are a plurality of measurement periods, the physical quantity converting unit modifies the corresponding discoloration map for the next measurement period, based on the color information of each sensor measured after the previous measurement period, and specifies an area within each discoloration map corresponding to the color information of each sensor measured during the next measurement period, according to the modified discoloration map.

9. The quality visualization system according to claim 6, characterized in that
of the plural sensors attached to the object, one sensor comprises an ink with a faster color changing speed and saturated color information strongly depending on temperature, and the other sensor comprises an ink with a slower color changing speed than the above sensor and a small difference of the color information in the temperature.

10. (canceled)

11. The quality visualization system according to claim 7, characterized in that
of the plural sensors attached to the object, one sensor comprises an ink with a faster color changing speed and saturated color information strongly depending on temperature, and the other sensor comprises an ink with a slower color changing speed than the above sensor and a small difference of the color information in the temperature.

12. The quality visualization system according to claim 8, characterized in that
of the plural sensors attached to the object, one sensor comprises an ink with a faster color changing speed and saturated color information strongly depending on temperature, and the other sensor comprises an ink with a slower color changing speed than the above sensor and a small difference of the color information in the temperature.
